(19) United States
(12) Patent Application Publication
(10) Pub. No.: US 2020/0398743 A1
(43) Pub. Date: Dec. 24, 2020

(54) Method and apparatus for learning how to notify pedestrians

(71) Applicant: GM GLOBAL TECHNOLOGY OPERATIONS LLC, Detroit, MI (US)

(72) Inventors: Marcus J. Huber, Saline, MI (US); Miguel A. Saez, Clarkston, MI (US); Qinglin Zhang, Novi, MI (US); Sudhakaran Maydiga, Troy, MI (US); Lei Wang, Rochester Hills, MI (US)

(21) Appl. No.: 16/450,232

(22) Filed: Jun. 24, 2019

(51) Int. Cl. B60Q 1/52; B60R 21/34; B60W 30/095; B60W 40/105; G06K 9/62; G06K 9/00

(52) U.S. Cl. CPC B60Q 1/525; B60R 21/34; B60W 30/0956; B60W 30/0953; B60W 2550/10; G06K 9/6256; G06K 9/00805; G06K 9/00362; B60W 2520/06; B60W 40/105

(57) ABSTRACT

A method for optimal notification of a relevant object in a potentially unsafe situation includes training a machine learning model using a plurality of object parameters and a plurality of vehicle state parameters to generate a trained machine learning model. Output data is predicted using the trained machine learning model. The output data represents an optimal mode of notification and a set of notification parameters for a specific state of interaction between the vehicle and the relevant object.

### INTRODUCTION

The subject disclosure relates to systems and methods for detecting and obtaining information about objects around a vehicle, and more particularly relates to optimal notification of pedestrians in a potentially unsafe situation.

The travel of a vehicle along predetermined routes, such as on highways, roads, streets, paths, etc. can be affected by other vehicles, objects, obstructions, and pedestrians on, at or otherwise in proximity to the path. The circumstances in which a vehicle's travel is affected can be numerous and diverse. Vehicle communication networks using wireless technology have the potential to address these circumstances by enabling vehicles to communicate with each other and with the infrastructure around them. Connected vehicle technology (e.g., Vehicle to Vehicle (V2V) and Vehicle to Infrastructure (V2I)) can alert motorists of roadway conditions or potential collisions. Connected vehicles can also “talk” to traffic signals, work zones, toll booths, school zones, and other types of infrastructure. Further, using either in-vehicle or after-market devices that continuously share important mobility information, vehicles ranging from cars to trucks and buses to trains are able to “talk” to each other and to different types of roadway infrastructure. In addition to improving inter-vehicle communication, connected V2V and V2I applications have the potential to impact broader scenarios, for example, Vehicle to Pedestrian (V2P) communication.

Accordingly, it is desirable to utilize V2P communication to improve pedestrian safety.

### SUMMARY

In one exemplary embodiment described herein is a method for optimal notification of a relevant object in a potentially unsafe situation. The method includes training a machine learning model using a plurality of object parameters and a plurality of vehicle state parameters to generate a trained machine learning model. Output data is predicted using the trained machine learning model. The output data represents an optimal mode of notification and a set of notification parameters for a specific state of interaction between the vehicle and the relevant object.

In addition to one or more of the features described above, or as an alternative, further embodiments of the method may include that the plurality of relevant object parameters includes at least a relevant object type, object location, speed of movement, direction of movement, pattern of movement.

In addition to one or more of the features described above, or as an alternative, further embodiments of the method may include that the relevant object type is a pedestrian and that the relevant object parameters include awareness state of the pedestrian and safety state of the pedestrian.

In addition to one or more of the features described above, or as an alternative, further embodiments of the method may include that the plurality of vehicle state parameters includes at least a gear state of the vehicle, speed of the vehicle, steering angle of the vehicle.

In addition to one or more of the features described above, or as an alternative, further embodiments of the method may include scanning vehicle surroundings using a plurality of vehicle sensors to identify the relevant object in a vicinity of the vehicle and determining a likelihood of a potential negative interaction between the vehicle and the relevant object in the vicinity of the vehicle, in response to identifying the relevant object. The method may further include determining the awareness state of the pedestrian, in response to determining that the relevant object type is a pedestrian and in response to determining that the likelihood of the potential negative interaction exceeds a predefined likelihood threshold, and training the machine learning model to render a notification for improving the safety state of the pedestrian, in response to determining that the safety state of the pedestrian is below a predefined safety level.

In addition to one or more of the features described above, or as an alternative, further embodiments of the method may include training the machine learning model to render a notification indicative of presence of the vehicle, in response to determining that the safety state of the pedestrian is below a predefined safety level. The set of notification parameters includes a projected vehicle path and safe distance information. The method further includes training the machine learning model to render a notification for improving the safety state of the pedestrian, in response to determining that the safety state of the pedestrian is below the predefined safety level.

In addition to one or more of the features described above, or as an alternative, further embodiments of the method may include that the optimal mode of notification includes zero or more notifications.

In addition to one or more of the features described above, or as an alternative, further embodiments of the method may include completing the training of the machine learning model, in response to a machine learning model's confidence value exceeding a predefined confidence threshold.

In addition to one or more of the features described above, or as an alternative, further embodiments of the method may include evaluating the predicted output data.

In addition to one or more of the features described above, or as an alternative, further embodiments of the method may include that the optimal mode of notification includes a visual notification. The set of notification parameters includes a graphical image of the visual notification.

Also described herein is another embodiment that is a multimodal system for optimal notification of a relevant object in a potentially unsafe situation. The multimodal system includes a plurality of vehicle sensors disposed on a vehicle. The plurality of sensors are operable to obtain information related to vehicle operating conditions and related to an environment surrounding the vehicle. The multimodal system further includes a vehicle information system operatively coupled to the plurality of vehicle sensors. The vehicle information system configured to train a machine learning model using a plurality of relevant object parameters and a plurality of vehicle state parameters to generate a trained machine learning model and configured to predict output data using the trained machine learning model. The output data represents an optimal mode of notification and a set of notification parameters for a specific state of interaction between the vehicle and the relevant object.

In addition to one or more of the features described above, or as an alternative, further embodiments of the system may include that the plurality of relevant object parameters includes at least a relevant object type, object location, speed of movement, direction of movement, pattern of movement.

In addition to one or more of the features described above, or as an alternative, further embodiments of the system may include that the relevant object type is a pedestrian.

In addition to one or more of the features described above, or as an alternative, further embodiments of the system may include that the plurality of vehicle state parameters includes at least a gear state of the vehicle, speed of the vehicle, steering angle of the vehicle.

In addition to one or more of the features described above, or as an alternative, further embodiments of the system may include that the vehicle information system is configured to scan vehicle surroundings using the plurality of vehicle sensors to identify the relevant object in a vicinity of the vehicle and configured to determine a likelihood of a potential negative interaction between the vehicle and the relevant object in the vicinity of the vehicle, in response to identifying the relevant object. The vehicle information system is further configured to determine an awareness state of the pedestrian, in response to determining that the relevant object type is a pedestrian and in response to determining that the likelihood of the potential negative interaction exceeds a predefined likelihood threshold and configured to train the machine learning model to render a notification for improving a safety state of the pedestrian, in response to determining that the safety state of the pedestrian is below a predefined safety level.

In addition to one or more of the features described above, or as an alternative, further embodiments of the system may include that the vehicle information system is configured to train the machine learning model to render a notification indicative of presence of the vehicle, in response to determining that the safety state of the pedestrian is below a predefined safety level. The set of notification parameters includes a projected vehicle path and safe distance information. The vehicle information system is further configured to train the machine learning model to render a notification for improving the safety state of the pedestrian, in response to determining that the safety state of the pedestrian is below the predefined safety level.

In addition to one or more of the features described above, or as an alternative, further embodiments of the system may include that the optimal mode of notification includes zero or more notifications.

In addition to one or more of the features described above, or as an alternative, further embodiments of the system may include that the vehicle information system is further configured to complete the training of the machine learning model, in response to a machine learning model's confidence value exceeding a predefined confidence threshold.

In addition to one or more of the features described above, or as an alternative, further embodiments of the system may include that the vehicle information system is further configured to evaluate the predicted output data.

In addition to one or more of the features described above, or as an alternative, further embodiments of the system may include that the optimal mode of notification includes a visual notification. The set of notification parameters includes a graphical image of the visual notification.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a configuration of an in-vehicle information system in accordance with an exemplary embodiment;

FIG. 2A is an example diagram of a vehicle having equipment for notifying potentially unsafe pedestrians in accordance with an exemplary embodiment;

FIG. 2B is an example diagram illustrating visual notification in accordance with an exemplary embodiment;

FIG. 2C is an example diagram illustrating alternative visual notification in accordance with an exemplary embodiment;

FIG. 3 is a flowchart of a process that may be employed for implementing one or more exemplary embodiments;

FIG. 4 is a flowchart of a training process to train a machine learning unit to predict optimal notification of a pedestrian in a potentially unsafe situation in accordance with an exemplary embodiment; and

FIGS. 5A-5C are pictorial diagrams illustrating how the machine learning unit can be employed to improve potentially unsafe situation in accordance with an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The following discussion generally relates to a system for learning whether to notify, and which modalities to use to notify, relevant objects in a vicinity of a moving vehicle in a potentially unsafe context in order to improve safety. In that regard, the following detailed description is merely illustrative in nature and is not intended to limit the invention or the application and uses of the invention. Furthermore, there is no intention to be bound by any expressed or implied theory presented in the preceding technical field, background, brief summary or the following detailed description. For the purposes of conciseness, conventional techniques and principles related to vehicle information systems, V2P communication, automotive exteriors and the like need not be described in detail herein.

In accordance with an exemplary embodiment described herein is an in-vehicle information system and a method of using a multimodal system for automatically determining the correct notification modality to maximize notification effectiveness. In an embodiment, to construct a model of the environment surrounding the corresponding vehicle, the in-vehicle information system collects data from a plurality of vehicle sensors (e.g., light detection and ranging (LIDAR), monocular or stereoscopic cameras, radar, and the like) that are disposed on the vehicle, analyzes this data to determine the positions and motion properties of relevant objects (obstacles) in the environment. The term “relevant objects” is used herein broadly to include, for example, other vehicles, cyclists, pedestrians, and animals (there may also be objects in the environment that are not relevant, such as small roadside debris, vegetation, poles, curbs, traffic cones, and barriers). In an embodiment, the in-vehicle information system may also rely on infrastructure information gathered by vehicle-to-infrastructure communication.

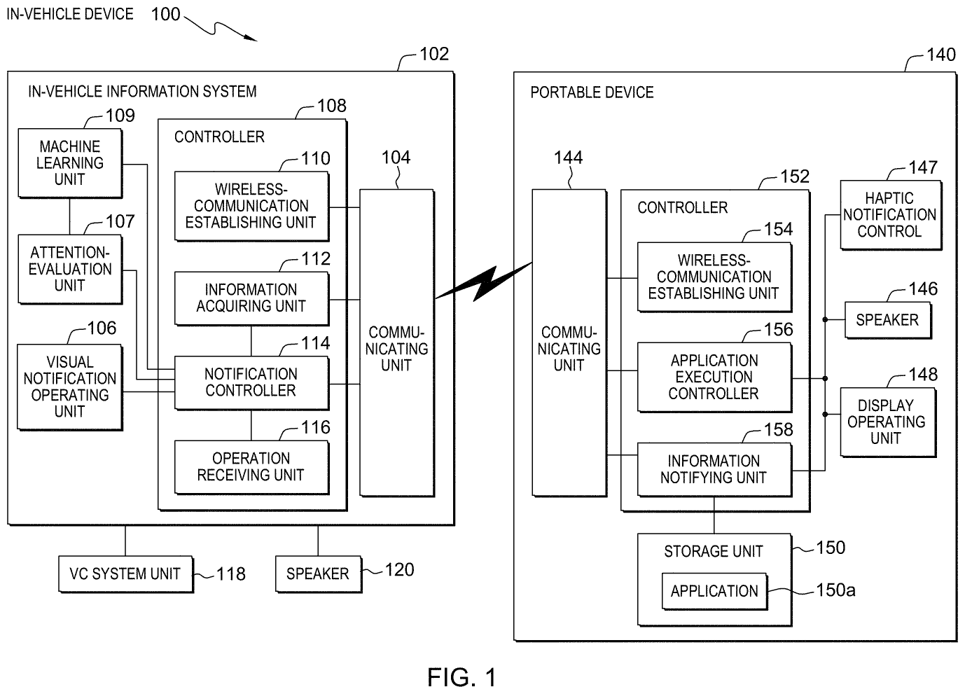

FIG. 1 is a block diagram of a configuration of an in-vehicle information system in accordance with an exemplary embodiment. Because an in-vehicle device 100 includes an in-vehicle information system 102 which communicates with a pedestrian's portable device 140, the respective devices are explained.

A configuration of in-vehicle information system 102 is explained first. As illustrated in FIG. 1, the in-vehicle information system 102 includes a communicating unit 104, a visual notification operating unit 106, an attention-evaluation unit 107, a controller 108, and a machine learning unit 109 and is connected to a vehicle control system (hereinafter, “VC system”) unit 118 and an audio speaker or buzzer system 120.

The VC system unit 118 is operatively coupled to the in-vehicle information system 102 and includes a plurality of vehicle sensors that are operable to obtain information related to vehicle operating conditions, such as a vehicle speed sensor, an acceleration sensor, a steering sensor, a brake sensor, and an indicator sensor, to detect speed of the vehicle (car speed), acceleration of the vehicle, positions of tires of the vehicle, an operation of the indicator, and a state of the brake. The audio speaker or buzzer system 120 controls audio notifications described herein.

Returning to the configuration of the in-vehicle information system 102, once a potentially unsafe pedestrian or another relevant object is detected, the communicating unit 104 establishes a communication link with the pedestrian's portable device 140, for example, by using short-distance wireless communication such as Bluetooth. The communicating unit 104 facilitates communication between the in-vehicle information system 102 and the portable device 140 by using the established communication link. Bluetooth is a short-distance wireless-communications standard to perform wireless communication in a radius of about dozens of meters by using a frequency band of 2.4 gigahertz. Bluetooth is widely applied to electronic devices such as mobile telephones and personal computers. At least in some embodiments, the communicating unit 104 controls wireless notifications described herein.

In accordance with the exemplary embodiment, while a case that communication between the in-vehicle information system 102 and the portable terminal 140 is performed by using Bluetooth is explained, other wireless communications standard such as Wi-Fi and ZigBee can be also used. Alternatively, wireless messaging communication can be also performed between the in-vehicle information system 102 and the portable device 140.

The visual notification operating unit 106 is connected to the controller 108, and also connected to a vehicle exterior projection system via a notification controller 114 in the controller 108. The visual notification operating unit 106 controls visual notifications described herein.

The controller 108 includes an internal memory for storing a control program such as an operating system (OS), a program specifying various process procedures, and required data, and also includes a wireless-communication establishing unit 110, an information acquiring unit 112, the notification controller 114, and an operation receiving unit 116 to perform various types of processes by these units.

When having detected a portable device of a pedestrian positioned at a predetermined distance allowing wireless communication with the in-vehicle information system 102, the wireless-communication establishing unit 110 establishes wireless communication with the detected portable device 140. Specifically, when the power of the in-vehicle device 100 is turned on, the wireless-communication establishing unit 110 activates the communicating unit 104, and searches whether there is a terminal in an area allowing wireless communication. When the portable device 140 enters an area allowing wireless communication, the wireless-communication establishing unit 110 detects the approaching portable device 140, and performs a pairing process using the communicating unit 104 with respect to the detected portable device 140, thereby establishing wireless communication with the portable device.

The information acquiring unit 112 acquires various types of data provided by various sensors included in the VC system unit 118. Specifically, the information acquiring unit 112 acquires, for example, vehicle operating conditions, V2V information and V2I information described in greater detail herein.

The attention-evaluation unit 107 analyzes received data to determine pedestrian's awareness of the environment. The pedestrian's awareness may be determined based on the acquired pedestrian parameters and may be compared to a predefined threshold. In some examples, the pedestrian can be presumed to be aware of vehicles that they have looked at, for example as determined by gaze tracking. However, there may be vehicles at which a pedestrian has looked, about which the pedestrian needs additional warnings because the pedestrian does not appear to have properly predicted that vehicle's current movements and/or state. Attention-evaluation unit 107 allows notification controller 114 warnings/notifications to be given selectively for pedestrian within the environment that have been classified as potentially unsafe. The attention state of pedestrians (pedestrians' awareness) is provided to the machine learning unit 109 as one of the machine learning unit's input features.

The machine learning unit 109 utilizes any known machine learning algorithms to process a plurality of relevant object parameters and a plurality of vehicle state parameters to infer optimal notification modes and optimal parameterization for such notifications. Thus, for example, machine learning unit 109 could include a neural network or a reinforcement learning algorithm. In one embodiment, the machine learning algorithms encompassed by machine learning unit 109 may include connectionist methods. Connectionist methods depend on numerical inputs. Thus, the plurality of relevant object parameters and the plurality of vehicle state parameters are transformed into numerical inputs before presenting information to the machine learning algorithms. The plurality of relevant object parameters may include at least a relevant object type, object location, speed of movement, direction of movement, pattern of movement, and the like. The operation of the machine learning unit 109 to infer optimal notification modes for the in-vehicle information system 102 will be described in further detail herein.

When there is a potentially unsafe pedestrian, machine learning unit 109 selects zero or more of the available communication modes and potentially renders pedestrian notification indicative of presence of the vehicle via the visual notification operating unit 106, the portable device 140, and/or the audio speaker or buzzer system 120. Specifically, the machine learning unit 109 may instruct the visual notification operating unit 106 to output a visual warning to the potentially unsafe pedestrian, using a spotlight or a laser projection system discussed herein. Further, in some embodiments the machine learning unit 109 selects to output an audio notification signal from the audio speaker or buzzer system 120 as an optimal notification option. Further, in some embodiments, the machine learning unit 109 selects to output a notification to the pedestrian mobile device 140 using the communication unit 104. Further, in some embodiments, the machine learning unit 109 selects to output no notifications, both a visual and an audio notification, or any other combination of notification modalities. Furthermore, the machine learning unit 109 determines what parameters to use with the selected notification as described herein.

A configuration of the pedestrian's portable device 140 is explained next. In various embodiments, the portable device 140 may include but is not limited to any of the following: a smart watch, digital computing glasses, a digital bracelet, a mobile internet device, a mobile web device, a smartphone, a tablet computer, a wearable computer, a head-mounted display, a personal digital assistant, an enterprise digital assistant, a handheld game console, a portable media player, an ultra-mobile personal computer, a digital video camera, a mobile phone, a personal navigation device, and the like. As illustrated in FIG. 1, the exemplary portable device 140 may include a communicating unit 144, a speaker 146, a haptic notification control unit 147, a display operating unit 148, a storage unit 150, and a controller 152.

The communicating unit 144 establishes a communication link with the in-vehicle information system 102 by using, for example, the short-distance wireless communication such as Bluetooth as in the communicating unit 104 of the in-vehicle information system 102 and performs communication between the portable device 140 and the in-vehicle information system 102 by using the established communication link.

The haptic notification control unit 147 is configured to generate haptic notifications. Haptics is a tactile and force feedback technology that takes advantage of a user's sense of touch by applying haptic feedback effects (i.e., “haptic effects” or “haptic feedback”), such as forces, vibrations, and motions, to the user. The portable device 140 can be configured to generate haptic effects. In general, calls to embedded hardware capable of generating haptic effects can be programmed within an operating system (“OS”) of the portable device 140. These calls specify which haptic effect to play. For example, when a user interacts with the device using, for example, a button, touchscreen, lever, joystick, wheel, or some other control, the OS of the device can send a play command through control circuitry to the embedded hardware. The embedded hardware of the haptic notification control unit 147 then produces the appropriate haptic effect.

Upon reception of the notification signal/message from application execution controller 156 or information notifying unit 158 in the controller 152 described herein, the display operating unit 148, which may include an input/output device such as a touch panel display, displays a text or an image received from the application execution controller 156 or the information notifying unit 158 in the controller 152.

The storage unit 150 stores data and programs required for various types of processes performed by the controller 152, and stores, for example, an application 150a to be read and executed by the application execution controller 156. The application 150a is, for example, the navigation application, a music download application, or a video distribution application.

The controller 152 includes an internal memory for storing a control program such as an operating system (OS), a program specifying various process procedures, and required data to perform processes such as audio communication, and also includes a wireless-communication establishing unit 154, the application execution controller 156, and the information notifying unit 158 to perform various types of processes by these units.

The wireless-communication establishing unit 154 establishes wireless communication with the in-vehicle information system 102. Specifically, when a pairing process or the like is sent from the in-vehicle information system 102 via the communicating unit 144, the wireless-communication establishing unit 154 transmits a response with respect to the process to the in-vehicle information system 102 to establish wireless communication.

The application execution controller 156 receives an instruction from a user of the portable device 140, and reads an application corresponding to the received operation from the storage unit 150 to execute the application. For example, upon reception of an activation instruction of the navigation application from the user of the portable device 140, the application execution controller 156 reads the navigation application from the storage unit 150 to execute the navigation application.

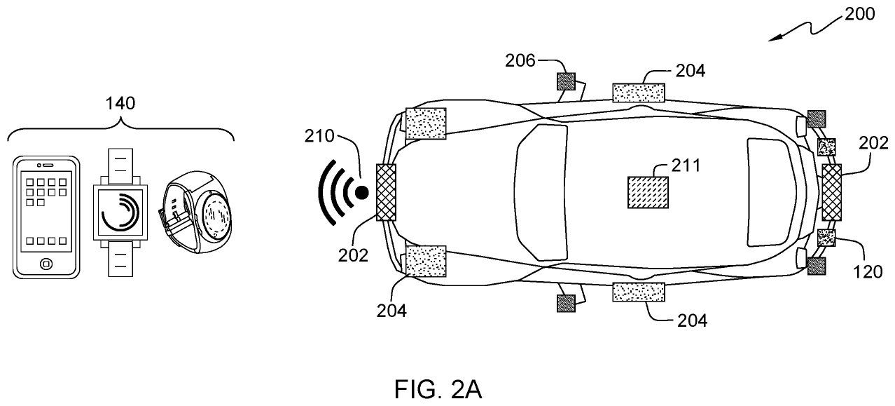

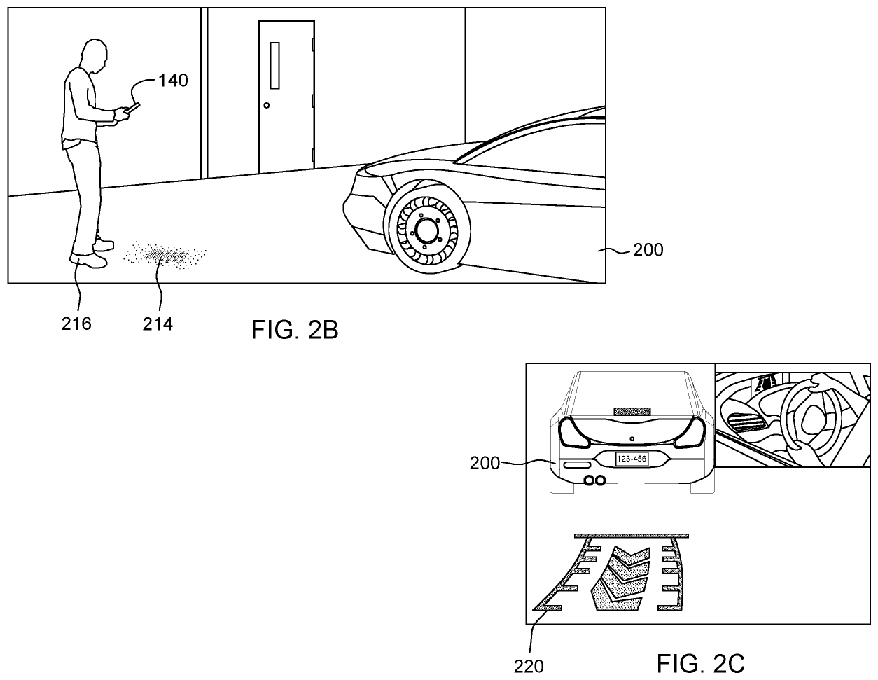

Referring to an exemplary automobile 200 illustrated in FIG. 2A, vehicular equipment coupled to the automobile 200 generally provides various modes of communicating with potentially unsafe pedestrians. As shown, the exemplary automobile 200 may include an exterior projection system, such as, one or more laser projection devices 202, other types of projection devices 206, spotlight digital projectors 204, and the like. The exemplary automobile may further include the audio speaker or buzzer system 120 and wireless communication devices 210. In an embodiment, the in-vehicle information system 102 employs the vehicle exterior projection system to project highly targeted images, pictures, spotlights and the like to improve safety of all relevant objects around the vehicle 200.

Further, the exemplary automobile 200 may include a plurality of sensors. One such sensor is a LIDAR device 211. The LIDAR 211 actively estimates distances to environmental features while scanning through a scene to assemble a cloud of point positions indicative of the three-dimensional shape of the environmental scene. Individual points are measured by generating a laser pulse and detecting a returning pulse, if any, reflected from an environmental object, and determining the distance to the reflective object according to the time delay between the emitted pulse and the reception of the reflected pulse. The laser, or set of lasers, can be rapidly and repeatedly scanned across a scene to provide continuous real-time information on distances to reflective objects in the scene. Combining the measured distances and the orientation of the laser(s) while measuring each distance allows for associating a three-dimensional position with each returning pulse. A three-dimensional map of points of reflective features is generated based on the returning pulses for the entire scanning zone. The three-dimensional point map thereby indicates positions of reflective objects in the scanned scene. Although in the embodiment of FIG. 2A, the LIDAR device 211 is shown on the top of the vehicle 200, it should be appreciated that the LIDAR device 211 may be located internally, on the front, on the sides etc. of the vehicle.

Still referring to the exemplary automobile 200 illustrated in FIG. 2A, the vehicle exterior projection system may include one or more projection devices 202, 206 (including laser projection devices 202) coupled to the automobile and configured to project an image onto a display surface that is external to automobile. The display surface may be any external surface. In one embodiment, the display surface is a region on the ground adjacent the automobile, or anywhere in the vicinity of the vehicle; in front, back, the hood, and the like.

The projected image may include any combination of images, pictures, video, graphics, alphanumerics, messaging, test information, other indicia relating to safety of relevant objects (e.g., potentially unsafe pedestrians) around vehicle 200. FIG. 2C is an example of a visual notification by laser projection devices 202 to notify all relevant objects of potential safety concerns in accordance with an exemplary embodiment. In various embodiments, in-vehicle information system 102 coupled with the vehicle exterior projection system may project images and render audible information associated with the vehicle's trajectory, and operation. For example, providing a visual and audible indication that vehicle 200 is moving forward, backward, door opening, “Help Needed” and the like, as well as illuminating the intended path of the vehicle. Exemplary image 220 (as shown in FIG. 2C) may include a notification indicative of presence of the vehicle 200 to a passing pedestrian or bicyclist. For example, image 220 displayed in the front or rear of vehicle 200 may illuminate and indicate the intended trajectory of vehicle. In various embodiments, the graphical image used for visual notification can change dynamically based on the speed of vehicle, vehicle operating mode and context, current and predicted direction of travel of the vehicle, objects around the vehicle and the like.

According to an embodiment, the vehicle exterior projection system may further include at least one spotlight digital projector 204 coupled to vehicle 200. Preferentially, spotlight digital projectors 204 are aligned in order to project a spotlight so that said spotlight is visible to the relevant objects when it strikes a suitable projection surface. Such a projection surface will generally be located outside of the motor vehicle 200; more preferably it can be a roadway surface, a wall or the like. Practically, at least one headlamp and/or at least one rear spotlight of vehicle 200 can be designed as said spotlight digital projector 204 in order to render the spotlight visible on a surface lit up by the headlamp/spotlight digital projector.

As shown in FIG. 2A, spotlight digital projectors 204 may be located at different sides of vehicle 200. In one embodiment, visual notification operating unit 106 can be practically set up to select spotlight digital projector 204 on the right side of vehicle 200 for projecting the spotlight when the potentially unsafe pedestrian is detected on the right side of vehicle 200, and to select spotlight digital projector 204 on the left side of vehicle 200 when the potentially unsafe pedestrian is detected on the left side of vehicle 200. Thus, the probability is high that the spotlight in each case is visible in the direction in which the potentially unsafe pedestrian happens to be looking.

FIG. 2B is an example of a visual notification in a form of spotlight image 214 projected by spotlight digital projector 204. Spotlight 214 shown in FIG. 2B indicates to potentially unsafe pedestrian 216 (or any other relevant object) the safe distance to vehicle 200. In one embodiment, visual notification operating unit 106 can determine a desirable location of the projected spotlight image based on the relative position of detected pedestrian 216. In other words, visual notification operating unit 106 is capable of moving the position of the visual notification spotlight image to actively track the position of the pedestrian.

Referring again to exemplary automobile 200 illustrated in FIG. 2A, in various embodiments, in-vehicle information system 102 may further render audible information associated with the vehicle's trajectory and operation to alert relevant objects to the presence of moving vehicle. In one embodiment, audio speaker or buzzer system 120 may be coupled to vehicle 200. Such audio speaker or buzzer system 120 may be used by in-vehicle information system 102 to notify relevant objects of a possible collision situation. Audio speaker or buzzer system 120 may be activated independently of the vehicle exterior projection system. In some embodiments, if in-vehicle information system 102 establishes a communication session with pedestrian's portable device 140 and determines that potentially unsafe pedestrian 216 (shown in FIG. 2B) is listening to music, simultaneously with activating audio speaker or buzzer system 120, notification controller 114 may send instructions to controller 152 of pedestrian's portable device 140 to temporarily mute or turn off the music potentially unsafe pedestrian 216 happens to be listening to. It should be noted that various notification modes discussed herein can be used separately or in any combination, including the use of all three notification modes (image projection, spotlight projection and audible notifications indicative of presence of the vehicle 200).

As shown in FIG. 2A, in-vehicle information system 102 (not shown in FIG. 2A) may also be coupled to one or more wireless communication devices 210. Wireless communication device 210 may include a transmitter and a receiver, or a transceiver of the vehicle 200. Wireless communication device 210 may be used by communicating unit 104 of the in-vehicle information system 102 (shown in FIG. 1) to establish a communication channel between vehicle 200 and pedestrian's portable device 140. The communication channel between portable device 140 and vehicle 200 may be any type of communication channel, such as, but not limited to, dedicated short-range communications (DSRC), Bluetooth, WiFi, Zigbee, cellular, WLAN, etc. The DSRC communications standard supports communication ranges of 400 meters or more.

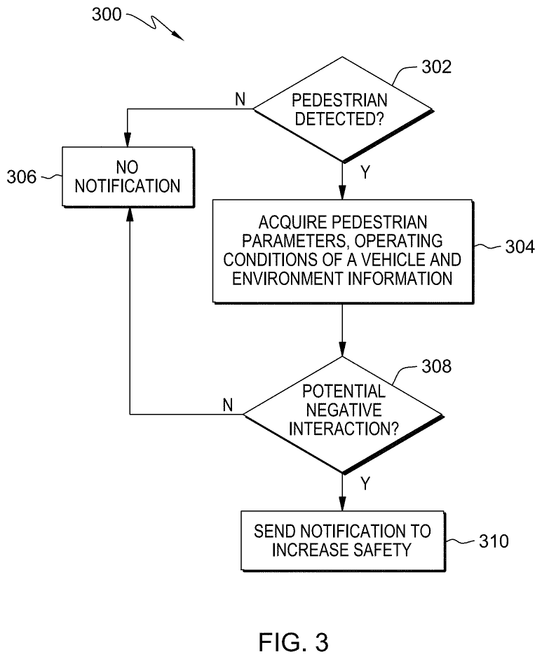

Referring to FIG. 3, there is shown a flowchart 300 of a process that may be employed for implementing one or more exemplary embodiments. At block 302, information acquiring unit 112 processes and analyzes images and other data captured by scanning vehicle surroundings to identify objects and/or features in the environment surrounding vehicle 200. The detected features/objects can include traffic signals, road way boundaries, other vehicles, pedestrians, and/or obstacles, etc. Information acquiring unit 112 can optionally employ an object recognition algorithm, a Structure From Motion (SFM) algorithm, video tracking, and/or available computer vision techniques to effect categorization and/or identification of detected features/objects. In some embodiments, information acquiring unit 112 can be additionally configured to differentiate between pedestrians and other detected objects and/or obstacles. In one exemplary embodiment, portable device 140 may be a V2P communication device. Accordingly, at block 302, wireless communication establishing unit 110 may receive a message from a pedestrian equipped with a V2P device. In one embodiment, the message received at block 302 may simply include an indication that there is a pedestrian in the vicinity of vehicle 200.

If information acquiring unit 112 determines that there are no pedestrians or other relevant objects in the environment surrounding vehicle 200 (decision block 302, “No” branch), notification controller 114 decides (block 306) that no notification is necessary. Responsive to detecting a pedestrian or another relevant object (decision block 302, “Yes” branch), at block 304, information acquiring unit 112 acquires one or more pedestrian parameters, such as the GPS coordinates of the pedestrian, the heading, speed or movement pattern of the pedestrian, gait, body posture, face recognition, hand gestures or other like parameters. In addition, information acquiring unit 112 predicts a potential path of travel of vehicle 200. Information acquiring unit 112 may utilize conventional methods of lane geometry determination and vehicle position determination including sensor inputs based upon vehicle kinematics, camera or vision system data, and global positioning/digital map data. In an additional embodiment, LIDAR 211 data may be used in combination or alternatively to the sensor inputs described herein above. It will be appreciated, that the potential paths of travel for the vehicle include multiple particle points descriptive of a potential safe passage for vehicle travel. The potential paths of travel can be combined or fused in one of more different combinations to determine a projected path of travel for the vehicle. In one embodiment, the potential paths of travel may be combined using weights to determine a projected vehicle path of travel. For example, a projected path of travel for vehicle 200 determined using global positioning/digital map data may be given greater weight than a potential path of travel determined using vehicle kinematics in predetermined situations. Further at block 304, information acquiring unit 112 may acquire environment information described in greater detail herein. Further, at block 304, information acquiring unit 112 sends all acquired information to the machine learning unit 109.

According to an embodiment, at block 308, notification controller 114 processes the received information to determine if there is a possibility of negative interaction between the vehicle 200 and one or more relevant objects. For example, notification controller 114 determines if there is a possibility of collision. Based on the processed information, the trained machine learning unit 109 determines whether any notification is necessary and what type of notification should be sent.

According to an embodiment, at block 308, notification controller 114 may employ attention-evaluation unit 107 to evaluate pedestrian's awareness/focus in order to determine if pedestrian notification is necessary. For example, attention-evaluation unit 107 may use the parameters acquired at block 304 to evaluate pedestrian awareness/focus. Evaluation of pedestrian's attention may include determining pedestrian's distraction level by estimating pedestrian awareness state based on the acquired pedestrian parameter, in response to determining that the likelihood of the potential negative interaction between the pedestrian and the vehicle 200 exceeds a predefined likelihood threshold.

In some embodiments, in-vehicle information system 102 may include two notification stages: an awareness stage and a warning. An awareness stage notification may include a visual notification/alert (such as visual notifications described herein) that may be selected by machine learning unit 109. According to embodiments, each notification modality may have one or more parameters associated therewith. For example, the trained machine learning unit 109 may determine that the visual alert/notification should include a particular graphic lit in yellow or amber to provide pedestrian's awareness of a vehicle in range of a danger zone. In this case the selected graphic image and color represent optimal notification parameters.

In response to determining that there is no possibility of negative interaction between the vehicle 200 and one or more relevant objects (decision block 308, “No” branch), notification controller 114 may decide that no notification is necessary (block 306). However, if notification controller 114 decides there exists a possibility of collision or another type of negative interaction between the vehicle 200 and at least one identified relevant object (decision block 308, “Yes” branch), at block 310, the trained machine learning unit 109 decides what type of notification to use to increase safety of the identified relevant objects. In various embodiments, alternative modes of notification can include, but are not limited to, communication via tactile, audio, visual, portable device and the like. At block 310, machine learning unit 109 may select zero or more modes of notification and may communicate the selected mode(s) to notification controller 114. In turn, notification controller may engage visual notification operating unit 106, for example, to project spotlight 214 (as shown in FIG. 2B) using spotlight digital projector 204 to notify a pedestrian (like pedestrian 216 in FIG. 2B) of potential collision with the vehicle and to indicate a safe distance in accordance with an exemplary embodiment. In this case the visual alert may turn to red (based on the decision of the machine learning unit 109). If the notification proves to be ineffective and if the notification controller 114 calculates that the pedestrian and vehicle 200 are still on a collision course, the machine learning unit 109 may warn audibly next, using audio speaker or buzzer system 120.

According to an embodiment, after sending the selected notification, if the notification controller 114 determines that pedestrian or another relevant object is still in a potentially unsafe situation, at block 310, the machine learning system 109 may decide to send a different type of notification. For example, if attention evaluation unit 107 determines that potentially unsafe pedestrian 216 (shown in FIG. 2B) listens to the music, machine learning unit 109 may send instructions (via notification controller 114) to controller 152 of pedestrian's portable device 140 to temporarily mute or turn off the music the potentially unsafe pedestrian 216 happens to be listening to. It should be noted that various notification modes discussed above can be used separately or in any combination, including the use of all multiple notification modes simultaneously (e.g., image projection, spotlight projection and audible notifications).

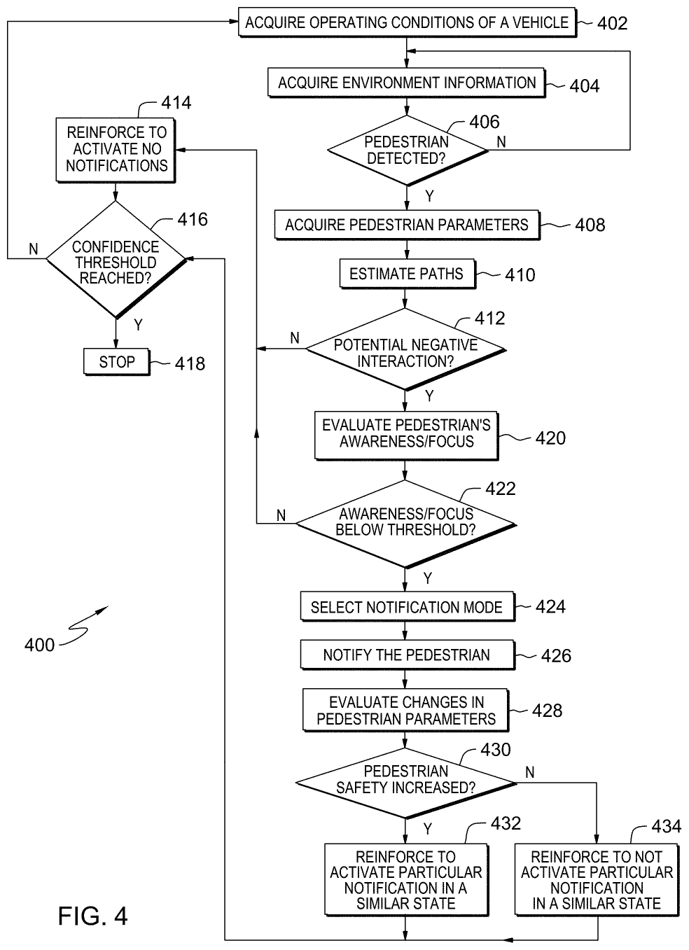

Referring to FIG. 4, there is shown a flowchart 400 of a training process to train a machine learning unit to predict output data (optimal notification of a pedestrian in a potentially unsafe situation) in accordance with an exemplary embodiment. The flowchart of FIG. 4. illustrates a particular embodiment implementing reinforcement learning machine learning technique. At block 402, information acquiring unit 112 determines operating conditions of the vehicle 200. Vehicle operating conditions (vehicle state) may include, but are not limited to, engine speed, speed of the vehicle, ambient temperature, gear state of the vehicle, steering angle of the vehicle, and the like. Further, operating conditions may include selecting a route to a destination based on driver input or by matching a present driving route to driving routes taken during previous trips. The operating conditions may be determined or inferred from a plurality of sensors employed by VC system unit 118.

At block 404, information acquiring unit 112 also takes advantage of other sources, external to vehicle 200, to collect information about the environment. The use of such sources allows information acquiring unit 112 to collect information that may be hidden from the plurality of sensors (e.g., information about distant objects or conditions outside the range of sensors), and/or to collect information that may be used to confirm (or contradict) information obtained by the plurality of sensors. For example, multimodal in-vehicle information system 102 may include one or more interfaces (not shown in FIG. 1) that are configured to receive wireless signals using one or more “V2X” technologies, such as V2V and V2I technologies. In an embodiment in which in-vehicle information system 102 is configured to receive wireless signals from other vehicles using V2V, for example, information acquiring unit 112 may receive data sensed by one or more sensors of one or more other vehicles, such as data indicating the configuration of a street, or the presence and/or state of a traffic control indicator, etc. In an example embodiment in which in-vehicle information system 102 is configured to receive wireless signals from infrastructure using V2I, information acquiring unit 112 may receive data provided by infrastructure elements having wireless capability, such as dedicated roadside stations or “smart” traffic control indicators (e.g., speed limit postings, traffic lights, etc.), for example. The V2I data may be indicative of traffic control information (e.g., speed limits, traffic light states, etc.), objects or conditions sensed by the stations, or may provide any other suitable type of information (e.g., weather conditions, traffic density, etc.). In-vehicle information system 102 may receive V2X data simply by listening/scanning for the data or may receive the data in response to a wireless request sent by in-vehicle information system 102, for example. More generally, multimodal in-vehicle information system 102 may be configured to receive information about external objects and/or conditions via wireless signals sent by any capable type of external object or entity, such as an infrastructure element (e.g., a roadside wireless station), a commercial or residential location (e.g., a locale maintaining a WiFi access point), etc. At least in some embodiments, at block 404, information acquiring unit 112 may scan vehicle surroundings using one or more LIDAR devices 211.

At block 406, information acquiring unit 112 processes and analyzes images and other data captured by scanning the environment to identify objects and/or features in the environment surrounding vehicle 200. This step may include classification of detected objects based on the shape, for example. As noted above, information acquiring unit 112 can optionally employ an object recognition algorithm, a Structure From Motion (SFM) algorithm, video tracking, and/or available computer vision techniques to effect categorization and/or identification of detected features/objects. In some embodiments, detected objects may include people, bicyclists, animals, and the like.

Responsive to detecting a pedestrian or another relevant object (decision block 406, “Yes” branch), at block 408, information acquiring unit 112 acquires one or more pedestrian (object) parameters, such as the GPS coordinates of the pedestrian, the heading, speed or movement pattern of the pedestrian, gait, body posture, face recognition, hand gestures or other like parameters. LIDAR 211 data may be used in combination or alternatively to the sensor inputs described herein above.

According to an embodiment, at block 410, information acquiring unit 112 predicts a potential path of travel of vehicle 200. As noted above, information acquiring unit 112 may utilize conventional methods of lane geometry determination and vehicle position determination including sensor inputs based upon vehicle kinematics, camera or vision system data, and global positioning/digital map data. It will be appreciated, that the potential paths of travel for the vehicle include multiple particle points descriptive of a potential safe passage for vehicle travel. The potential paths of travel can be combined or fused in one of more different combinations to determine a projected path of travel for the vehicle. In some embodiment, the behavior-prediction module of the machine learning unit 109 may output predicted future motion corresponding to one or more pedestrians captured in the acquired image data. The pedestrian typically moves slowly compared to the vehicle 200 and therefore the longitudinal motion of the pedestrian can be ignored. The lateral motion of the pedestrian, whether into the path of the vehicle 200 or away from the path of the vehicle 200 is critical. It will be appreciated that prediction of the potential paths of travel include prediction of future locations and prediction of future maneuvers.

At block 412, information acquiring unit 112 may compute probability of a possible collision between the vehicle 200 and the detected pedestrian by computing the future positions of both vehicle 200 and the detected pedestrian based on the combined acquired information (e.g., position and speed information of the detected pedestrian and vehicle 200). In other words, at block 410, information acquiring unit 112 automatically determines a likelihood of a potential collision between the vehicle 200 and the detected pedestrian.

If information acquiring unit 112 identifies no relevant objects (decision block 406, “No” branch) or if information acquiring unit 112 determines that the probability of a possible collision between the vehicle 200 and the detected pedestrian is low (decision block 412, “No” branch), notification controller 114 decides that no notification is necessary in a currently observed situation.

According to an embodiment, at block 412, information acquiring unit 112 may send a plurality of acquired object parameters (e.g., pedestrian parameters), a plurality of vehicle state parameters (e.g., acquired operating conditions of the vehicle 200) and combined estimated path information to machine learning unit 109. These parameters may be employed as input parameters by a corresponding machine learning model. If notification controller 114 determines that the probability of a potential negative interaction between the vehicle 200 and the detected pedestrian is high (decision block 412, “Yes” branch), at block 420, attention-evaluation unit 107 evaluates pedestrian's awareness/focus and provides this information to machine learning unit 109. For example, attention-evaluation unit 107 may use the parameters acquired at block 304 to evaluate pedestrian awareness/focus. The evaluation of pedestrian's attention may include determining pedestrian's distraction level by estimating pedestrian awareness state based on the acquired pedestrian parameters. Based on all of the acquired information, machine learning unit 109 determines if pedestrian notification is necessary.

According to an embodiment, at block 422, notification controller 114 determines if the pedestrian is in a potentially unsafe situation. For example, notification controller 114 may determine if pedestrian's safety is below a predefined threshold. If pedestrian's safety is not below the predefined threshold (decision block 422, “No” branch), machine learning unit 109 learns not to activate notifications in similar situations (at block 414).

In at least one of the various embodiments, at block 416, the input data may be processed using a machine learning model. In at least one of the various embodiments, a confidence value may be generated and associated with the predicted output data. In at least one of the various embodiments, the machine learning model may be arranged to re-train according to a defined schedule. In other embodiment, the machine learning model may be arranged to re-train if a number of detected notification errors (e.g., false positive, label conflicts, or the like) exceeds a defined threshold. In at least one of the various embodiments, an increase in notification errors may indicate that there have been changes in the input data that the model may not be trained to recognize. Accordingly, at block 416, machine learning unit 109 may determine if generated machine learning model's confidence value exceeds the predefined confidence threshold. If the generated confidence value is below the threshold (decision block 416, “No” branch), the disclosed training process returns to block 402. However, if the machine learning model's confidence value reaches the defined threshold (decision block 416, “Yes” branch), the training process stops at block 418.

According to an embodiment, if the notification controller 114 determines that the pedestrian is potentially unsafe (decision block 422, “Yes” branch), the machine learning model of the machine learning unit 109 may select a particular pedestrian notification mode at block 424. In various embodiments, alternative modes of notification can include, but are not limited to, communication via tactile, audio, visual, portable device and the like. For example, machine learning unit 109 may first select visual communication, such as spotlight projection. In addition, machine learning unit 109 may further select one or more parameters associated with the selected mode of notification. For example, machine learning unit 109 may select optimal image and/or color of the selected visual notification, particular sound frequency, particular image movement pattern, and the like.

Accordingly, at block 426, notification controller 114 notifies the pedestrian using the selected mode of notification and using a set of notification parameters. For example, notification controller 114 may engage visual notification operating unit 106 to project spotlight 214 (as shown in FIG. 2B) using spotlight digital projector 204 to notify a potentially unsafe pedestrian (like pedestrian 216 in FIG. 2B) of potential collision with the vehicle in accordance with an exemplary embodiment.

At block 428, notification controller 114 evaluates changes in the pedestrian parameters to determine if a safety state of the pedestrian is below a predefined safety level. In one embodiment, notification controller 114 may analyze the changes in the pedestrian parameters to determine whether the notification sent at block 426 was effective and whether there are any changes with respect to pedestrian's safety state at block 430. In one embodiment, this evaluation may be made by evaluating pedestrian's safety zone. A safety zone may expand in a cone shape in front of the vehicle. The faster a potential endangered pedestrian is, the more time he or she may have to walk in front of the approaching vehicle.

If notification controller 114 determines that pedestrian safety state has been improved and/or may no longer be below the predefined safety level as a result of the issued notification (decision block 430, “Yes” branch), notification controller 114 may indicate to machine learning unit 109 (block 432) that the notification type selected at block 424 should be used in the future in a similar state. In this case, notification controller 114 may send the determined pedestrian's safety indicator as yet another input parameter for the corresponding machine learning model. However, if notification controller 114 determines that the safety state of the pedestrian has not changed and/or has not improved as a result of the issued notification (decision block 430, “No” branch), notification controller 114 may indicate to machine learning unit 109 (block 434) that the notification type selected at block 424 should not be activated in the future in a similar state. In other words, notification controller 114 trains machine learning unit 109 based on pedestrian's response to the selected mode of notification and/or based on response to the selected notification parameters.

According to an embodiment, from blocks 432, 434 the training process may jump to block 416 to determine whether the aforementioned predefined confidence threshold has been reached. If so, the training process completes at block 418, otherwise it returns back to block 402.

It will be appreciated that machine learning unit 109 may employ quite many different types of machine learning algorithms including implementations of a reinforcement learning algorithm, classification algorithm, a neural network algorithm, a regression algorithm, a decision tree algorithm, or even algorithms yet to be invented. Training may be supervised, semi-supervised, or unsupervised. Once trained, the trained model of interest represents what has been learned or rather the knowledge gained from training data as described herein. The trained model can be considered a passive model or an active model. A passive model represents the final, completed model on which no further work is performed. An active model represents a model that is dynamic and can be updated based on various circumstances. In some embodiments, the trained model employed by machine learning unit 109 is updated in real-time, on a daily, weekly, bimonthly, monthly, quarterly, or annual basis. As new information is made available (e.g., shifts in time, new or corrected pedestrian parameters, etc.), an active model will be further updated. In such cases, the active model carries metadata that describes the state of the model with respect to its updates.

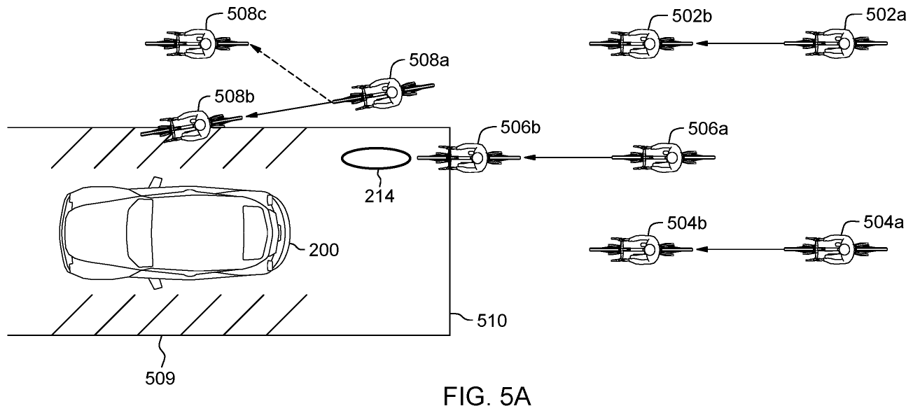

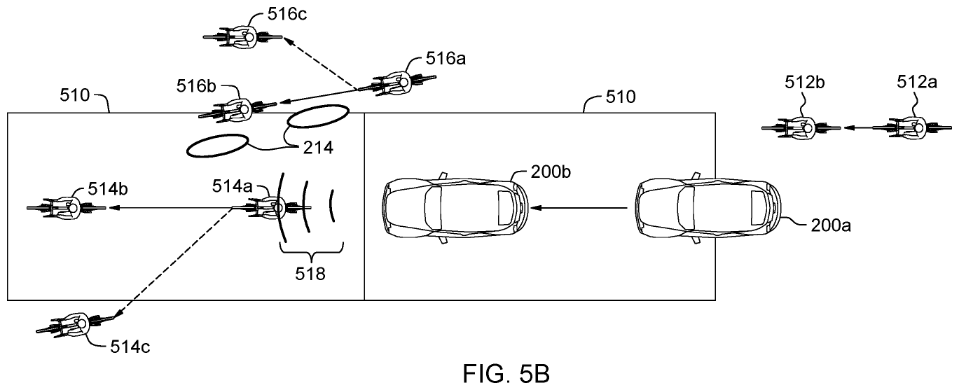

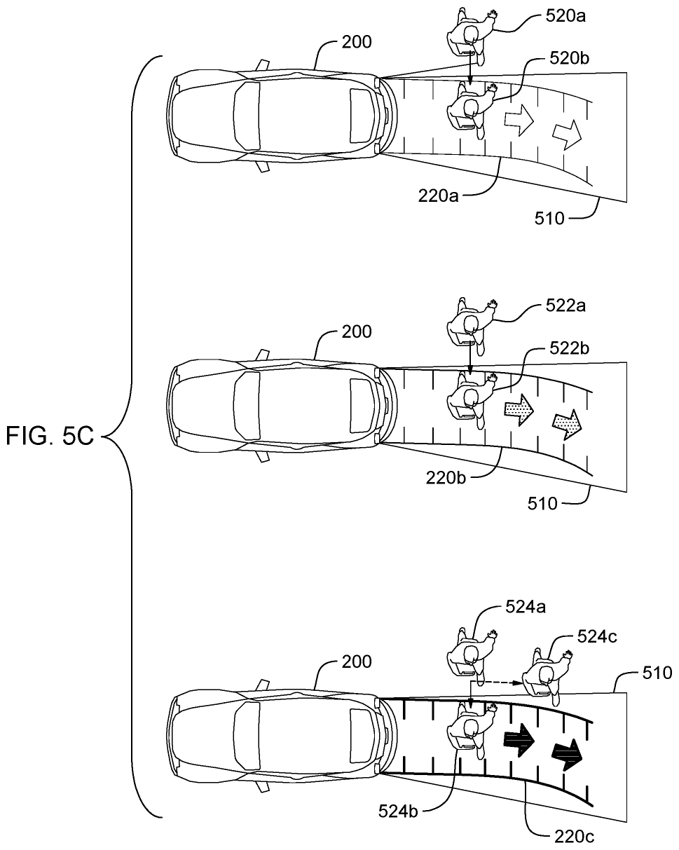

FIGS. 5A-5C are pictorial diagrams illustrating how the machine learning unit 109 can be employed to improve potentially unsafe situation in accordance with an exemplary embodiment. FIG. 5A illustrates a few scenarios involving the vehicle 200 and a plurality of bicyclists approaching the vehicle 200 from different sides. The vehicle 200 could be travelling at the constant relatively low speed. A first bicyclist 502a and a second bicyclist 504a could be approaching the vehicle 200 from behind. After detecting the first 502a and second 504a bicyclists and acquiring corresponding parameters, the information acquiring unit 112 predicts a potential path of travel of the vehicle 200, the first bicyclist 502a and the second bicyclist 504a (as described herein in conjunction with block 410 of FIG. 4). In addition, the information acquiring unit 112 may calculate a projected position 502b of the first bicyclist and a projected position 504b of the second bicyclist. In this case, the information acquiring unit 112 may determine that the projected positions 502b and 504b of the first and second bicyclists are too far behind with respect to a projected danger zone 510 and the probability of a possible collision between the vehicle 200 and the bicyclists is low. Accordingly, if bicyclist's safety is not below a predefined threshold, machine learning unit 109 learns not to activate notifications in similar situations (block 414 of FIG. 4).

Still referring to FIG. 5A, the third bicyclist 506a could be approaching the vehicle 200 from behind at a higher rate of speed. The information acquiring unit 112 may calculate a projected position 506b of the third bicyclist. In this case, notification controller 114 may determine that the probability of a potential negative interaction between the vehicle 200 and the third bicyclist 506a is high (decision block 412, “Yes” branch of FIG. 4). Accordingly, notification controller 114 may ask the machine learning unit 109 to select a particular notification mode. In the illustrated example, the machine learning unit 109 selects a visual notification in a form of spotlight 214 projected by the spotlight digital projector 204 (shown in FIG. 2A). Spotlight 214 shown in FIG. 5A indicates to the third bicyclist 506a the safe distance to the vehicle 200. However, the third bicyclist 506a may still enter the projected danger zone 510. Accordingly, in this case, notification controller 114 trains the machine learning unit 109 not to use spotlight notification for such a state (block 434 of FIG. 4).

Yet another (fourth) bicyclist 508a could be approaching the vehicle 200 from a side. The information acquiring unit 112 may calculate a projected position 508b of the fourth bicyclist. In this case, notification controller 114 may determine that the probability of a potential negative interaction between the vehicle 200 and the fourth bicyclist 508a is high (decision block 412, “Yes” branch of FIG. 4). Accordingly, notification controller 114 may ask again the machine learning unit 109 to select a particular notification mode. In this case, the machine learning unit 109 selects another type of visual notification in a form of the danger zone image 509 projected by spotlight digital projector 204 (shown in FIG. 2A). As a result of rendering the danger zone image 509, the fourth bicyclist 508a changes course away from the danger zone 510 to a future position 508c. In this case, after re-evaluating parameters associated with the fourth bicyclist 508a, notification controller 114 determines that a safety state of the fourth bicyclist 508a has improved and trains the machine learning unit 109 to reinforce the danger zone image notification 509 for such a state (block 432 of FIG. 4).

FIG. 5B illustrates few more scenarios involving the vehicle 200 and a plurality of bicyclists detected in the vicinity of the vehicle 200. In FIG. 5B, both the current position 200a and estimated future position 200b of the vehicle are shown. After detecting the first bicyclist 512a and acquiring corresponding parameters, the information acquiring unit 112 predicts a potential path of travel of the first bicyclist 512a and may calculate the projected position 512b of the first bicyclist. In this case, the information acquiring unit 112 may determine again that the first bicyclist is falling behind the vehicle based on projected positions 512b and 200b of the first bicyclist and the vehicle, respectively. Accordingly, if first bicyclist's 512a safety is not below a predefined threshold (block 414 of FIG. 4), machine learning unit 109 learns not to activate notifications in similar situations.

Still referring to FIG. 5B, the second bicyclist 514a could be travelling ahead of the vehicle 200. The information acquiring unit 112 may calculate a projected position 514b of the second bicyclist. In this case, the information acquiring unit 112 may determine that the projected position 514b of the second bicyclist 514a is within the projected danger zone 510 and the notification controller 114 may determine that the probability of a potential negative interaction between the vehicle 200 and the second bicyclist 514a is high (decision block 412, “Yes” branch of FIG. 4). Accordingly, notification controller 114 may ask the machine learning unit 109 to select a particular notification mode. In this case, the machine learning unit 109 selects an audible notification 518 rendered by the audio speaker or buzzer system 120 (shown in FIG. 1). The audible notification 518 alerts the second bicyclist 514a of the approaching vehicle 200. As a result of rendering the audible notification 518, the second bicyclist 514a changes course away from the danger zone 510 to a future position 514c. In this case, after re-evaluating parameters associated with the second bicyclist 514a, notification controller 114 determines that the safety state of the second bicyclist 514a has improved and trains the machine learning unit 109 to reinforce the audible notification 518 for such a state (block 432 of FIG. 4).

Yet another (third) bicyclist 516a could be approaching the vehicle 200 from a side. The information acquiring unit 112 may calculate a projected position 516b of the third bicyclist. In this case, the notification controller 114 may determine again that the probability of a possible negative interaction between the vehicle 200 and the third bicyclist 516a is high (decision block 412, “Yes” branch of FIG. 4). Accordingly, notification controller 114 may ask the machine learning unit 109 to select a particular notification mode. In this case, the machine learning unit 109 selects a spotlight notification. One or more spotlights 214 shown in FIG. 5B indicate to the third bicyclist 516a the safe distance to the vehicle 200. As a result of rendering spotlight notification 214, the third bicyclist 516a changes course away from the danger zone 510 to a future position 516c. In this case, after re-evaluating parameters associated with the third bicyclist 516a, notification controller 114 determines that the safety state of the third bicyclist 516a has improved and trains the machine learning unit 109 to reinforce the spotlight notification 214 for such a state (block 432 of FIG. 4).

FIG. 5C illustrates a few scenarios involving the vehicle 200 backing up from a stop and a plurality of potentially unsafe pedestrians 520a, 522a, 524a approaching the danger zone 510. The vehicle 200 could be travelling backwards at the relatively low speed. After detecting the first potentially unsafe pedestrian 520a and acquiring corresponding pedestrian parameters, the information acquiring unit 112 predicts a potential path of travel of the vehicle 200 and the first potentially unsafe pedestrian 520a and may calculate a projected position 520b of the first potentially unsafe pedestrian. In this case, the information acquiring unit 112 may determine that the first potentially unsafe pedestrian 520a is likely to enter the danger zone 510. Accordingly, notification controller 114 may ask the machine learning unit 109 to select a particular notification mode. In this case, the machine learning unit 109 selects a visual notification 220a indicating the intended trajectory of vehicle 200. In addition, the machine learning unit 109 selects yellow color as a notification parameter. In other words, the visual notification 220a is projected in yellow color. However, the first potentially unsafe pedestrian 520a enters the danger zone 510 anyway. In this case, after re-evaluating parameters associated with the first potentially unsafe pedestrian 520a, notification controller 114 determines that the safety state of the first potentially unsafe pedestrian 520a has not improved and trains the machine learning unit 109 not to use yellow color parameter with this particular notification mode for such a state.

Similarly, after detecting the second potentially unsafe pedestrian 522a and acquiring corresponding pedestrian parameters, the information acquiring unit 112 predicts a potential path of travel of the vehicle 200 and the second potentially unsafe pedestrian 522a and may determine that the second potentially unsafe pedestrian 522a is also likely to enter the danger zone 510. In this case, the machine learning unit 109 selects similar visual notification 220b but this time the color is orange. However, just like in the first illustrated case, the second potentially unsafe pedestrian 520a enters the danger zone 510 anyway. As a result, the notification controller 114 trains the machine learning unit 109 to avoid orange color parameter as well. Still referring to FIG. 5C, in the case of the third potentially unsafe pedestrian 524a, the machine learning unit 109 changes a notification parameter yet again and picks red color this time for the visual notification 220c. Unlike the previous two cases, the third potentially unsafe pedestrian 524a does not enter the danger zone 510 and changes course to position 524c instead of the predicted position 524b. In this case, after re-evaluating parameters associated with the third potentially unsafe pedestrian 524a, notification controller 114 determines that the safety state of the third potentially unsafe pedestrian 524a has improved and trains the machine learning unit 109 to reinforce red color parameter with the visual notification 220c for such a state (block 432 of FIG. 4). Once the training is complete, output data is predicted using the trained machine learning model for a variety of situations. The predicted output data represents an optimal mode of notification (zero or more) and optionally a set of notification parameters for a specific state of interaction between the vehicle and the object.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

1. A method for optimal notification of a relevant object in a potentially unsafe situation, the method comprising:
training a machine learning model using a plurality of relevant object parameters and a plurality of vehicle state parameters to generate a trained machine learning model; and
predicting output data using the trained machine learning model, wherein the output data represents an optimal mode of notification and a set of notification parameters for a specific state of interaction between a vehicle and the relevant object, wherein the optimal mode of notification includes zero or more notifications.

2. The method of claim 1, wherein the plurality of relevant object parameters includes at least a relevant object type, object location, speed of movement, direction of movement, pattern of movement.

3. The method of claim 2, wherein the relevant object type is a pedestrian and wherein the relevant object parameters further include awareness state of the pedestrian and safety state of the pedestrian.

4. The method of claim 1, wherein the plurality of vehicle state parameters includes at least a gear state of the vehicle, speed of the vehicle, steering angle of the vehicle.

5. The method of claim 3, further comprising:
scanning vehicle surroundings using a plurality of vehicle sensors to identify the relevant object in a vicinity of the vehicle;
determining a likelihood of a potential negative interaction between the vehicle and the relevant object in the vicinity of the vehicle, in response to identifying the relevant object;
determining the awareness state of the pedestrian, in response to determining that the relevant object type is a pedestrian and in response to determining that the likelihood of the potential negative interaction exceeds a predefined likelihood threshold; and
training the machine learning model to render a notification for improving the safety state of the pedestrian, in response to determining that the safety state of the pedestrian is below a predefined safety level.

6. The method of claim 5, further comprising:
training the machine learning model to render a notification indicative of presence of the vehicle, wherein the set of notification parameters includes a projected vehicle path and safe distance information, in response to determining that the safety state of the pedestrian is below a predefined safety level; and
training the machine learning model to render a notification for improving the safety state of the pedestrian, in response to determining that the safety state of the pedestrian is below the predefined safety level.

7. (canceled)

8. The method of claim 1, further comprising completing the training of the machine learning model, in response to a machine learning model's confidence value exceeding a predefined confidence threshold.

9. The method of claim 1, further comprising evaluating the predicted output data.

10. The method of claim 1, wherein the optimal mode of notification comprises a visual notification and wherein the set of notification parameters includes a graphical image of the visual notification.

11. A multimodal system for optimal notification of a relevant object in a potentially unsafe situation, the system comprising:
a plurality of vehicle sensors disposed on a vehicle, the plurality of sensors operable to obtain information related to vehicle operating conditions and related to an environment surrounding the vehicle; and
a vehicle information system operatively coupled to the plurality of vehicle sensors, the vehicle information system configured to:
train a machine learning model using a plurality of relevant object parameters and a plurality of vehicle state parameters to generate a trained machine learning model; and
predict output data using the trained machine learning model, wherein the output data represents an optimal mode of notification and a set of notification parameters for a specific state of interaction between the vehicle and the relevant object, wherein the optimal mode of notification includes zero or more notifications.

12. The multimodal system of claim 11, wherein the plurality of relevant object parameters includes at least a relevant object type, object location, speed of movement, direction of movement, pattern of movement.

13. The multimodal system of claim 12, wherein the relevant object type is a pedestrian.

14. The multimodal system of claim 13, wherein the plurality of vehicle state parameters includes at least a gear state of the vehicle, speed of the vehicle, steering angle of the vehicle.

15. The multimodal system of claim 14, wherein the vehicle information system is further configured to:
scan vehicle surroundings using the plurality of vehicle sensors to identify the relevant object in a vicinity of the vehicle;
determine a likelihood of a potential negative interaction between the vehicle and the relevant object in the vicinity of the vehicle, in response to identifying the relevant object;
determine an awareness state of the pedestrian, in response to determining that the relevant object type is a pedestrian and in response to determining that the likelihood of the potential negative interaction exceeds a predefined likelihood threshold; and
train the machine learning model to render a notification for improving a safety state of the pedestrian, in response to determining that the safety state of the pedestrian is below a predefined safety level.

16. The multimodal system of claim 15, wherein the vehicle information system is further configured to:
train the machine learning model to render a notification indicative of presence of the vehicle, wherein the set of notification parameters includes a projected vehicle path and safe distance information, in response to determining that the safety state of the pedestrian is below a predefined safety level; and
train the machine learning model to render a notification for improving the safety state of the pedestrian, in response to determining that the safety state of the pedestrian is below the predefined safety level.

17. (canceled)

18. The multimodal system of claim 11, wherein the vehicle information system is further configured to complete the training of the machine learning model, in response to a machine learning model's confidence value exceeding a predefined confidence threshold.

19. The multimodal system of claim 11, wherein the vehicle information system is further configured to evaluate the predicted output data.

20. The multimodal system of claim 11, wherein the optimal mode of notification comprises a visual notification and wherein the set of notification parameters includes a graphical image of the visual notification.
